(19) United States
(12) Patent Application Publication
(10) Pub. No.: US 2023/0155518 A1
(43) Pub. Date: May 18, 2023

(54) ELECTRICAL POWER CONVERTER

(71) Applicant: PRODRIVE TECHNOLOGIES INNOVATION SERVICES B.V., Son en Breugel (NL)

(72) Inventor: Jordi EVERTS, Son en Breugel (NL)

(21) Appl. No.: 17/995,836

(22) PCT Filed: Apr. 12, 2021
(86) PCT No.: PCT/EP2021/059461

§ 371 Date: Oct. 7, 2022

(30) Foreign Application Priority Data
Apr. 10, 2020 (NL) 2025328

(51) Int. Cl. H02M 7/219; H02M 7/487; H02M 1/42; H02M 7/217; H02J 7/04

(52) U.S. Cl. CPC H02M 7/219; H02M 7/487; H02M 1/4216; H02M 1/4225; H02M 7/2173; H02J 7/04

(57) ABSTRACT

An electrical converter may include (i) m=3 phase input terminals, a neutral terminal and two output terminals, (ii) a first power stage comprising a bridge rectifier connected to each of the m phase input terminals and an output connected to an upper intermediate node and a lower intermediate node, (iii) a second power stage comprising an upper boost stage connected between the upper intermediate node and a common node, and a lower boost stage connected between the common node and the lower intermediate node, and (iv) a controller configured to operate according to a first mode of operation for converting the multi-phase AC input to the DC output or vice versa and according to a second mode of operation for converting a single phase AC input applied to at least one of the m phase input terminals and the neutral terminal to the DC output.

### TECHNICAL FIELD

The present disclosure relates to the field of electrical power conversion. In particular, the present disclosure relates to an electrical converter topology allowing to convert from both three phase AC power and single phase AC energy to DC power and vice versa, and to a method for controlling such an electrical converter.

### INTRODUCTION

It is known that some three phase AC to DC converter topologies can basically also be used for converting single phase AC to DC. To do so, one of the three phase input terminals is used as the forward conductor whereas another one of the three phase input terminals is used as the return conductor, and the third terminal is not used. The power that can be transferred between the AC side and the DC side in single phase AC to DC operation depends on the power rating of the electronic components that are connected in the current path of the phase input used for single phase operation. Typically, the power rating in single phase AC to DC operation will be about ⅓ of the power rating in three phase AC to DC operation. However, implementing single phase AC to DC operation in the three phase AC to DC converter is not straightforward and requires complex changes in the control of the converter.

A three phase AC to DC converter topology is known from WO 2020/035527, 20 Feb. 2020, also known as the Belgian Rectifier. The converter comprises a three phase rectifier bridge and a boost stage utilizing inductors of the AC input filter stage as energy storage elements for providing a DC output voltage higher than the AC input voltage.

### SUMMARY

It is an objective of the present disclosure to provide a low cost electrical converter topology that can be efficiently used both for three (multi)-phase boost-type PFC AC-DC conversion and for single phase boost type PFC AC-DC conversion. It is an objective to provide such an electrical converter topology allowing to have a same power rating in three (multi)-phase and in single phase operation, advantageously without added complexity and with minimal cost.

According to a first aspect of the present disclosure, there is therefore provided an electrical converter as set out in the appended claims.

An electrical converter according to aspects of the present disclosure allows for converting electrical energy between a multi-phase AC input having m grid phase terminals and a DC output, wherein m=3. The electrical converter comprises: (i) m phase input terminals, a neutral terminal and two output (DC) terminals, (ii) a first power stage comprising a bridge rectifier with first active switches connected to each of the m phase input terminals and an output connected to an upper intermediate node and a lower intermediate node, (iii) an input filter for filtering AC currents applied to the m phase input terminals, (iv) a second power stage comprising an upper boost stage comprising a second active switch connected between the upper intermediate node and a common node, and a lower boost stage comprising a third active switch connected between the common node and the lower intermediate node, (v) an output filter comprising at least one filter capacitor arranged between the second power stage and the output terminals, and (vi) a controller configured to operate according to a first mode of operation for converting the multi-phase AC input to the DC output or vice versa. To this end, the controller is operably connected to the first, second and third active switches. The common node is connected to the neutral terminal.

According to the present disclosure, the controller is configured to operate according to a second mode of operation for converting a single phase AC input to the DC output or vice versa. The single phase AC input is applied between at least one of the m phase input terminals and the neutral terminal. That is, the forward conductor of the single phase AC input is connected to at least one of the m phase input terminals and the return conductor is connected to the neutral terminal. The m phase input terminals not connected to the forward conductor are advantageously not used, i.e. disconnected. In the second mode of operation, the controller is advantageously configured to operate the first switches through pulse width modulation. By so doing, a rectified (DC) voltage is obtained at the output terminals. The second and third switches can but need not be operated.

The second and third switches advantageously each comprise a diode arranged in anti-parallel. The second and third switches are advantageously configured to assume inverse (i.e., complementary) states in the second mode of operation. In case the second and third switches are not operated, the second mode of operation is obtained through the anti-parallel diodes which will assume inverse states, i.e., one of the anti-parallel diodes of the second and the third switch is conducting current, and the other one is blocking current.

It will be convenient to note that the terms forward conductor and return conductor of a single phase AC input can be used interchangeably.

According to the present disclosure, to allow the converter to operate both in the second mode of operation and in the first mode of operation, the output filter can be arranged according to the following possible configurations:
a) the output filter comprises a midpoint node (e.g. it comprises at least two filter capacitors in series between the output terminals allowing to define a midpoint node), and the common node is connected to the midpoint node through a fourth switch,
b) the output filter comprises a midpoint node and the common node is (permanently) not connected to the midpoint node,
c) the output filter does not comprise a midpoint node hence eliminating possibility of connecting the common node to (a midpoint node of) the output filter.
   Advantageously, in configuration (a), the controller is configured to open the fourth switch for interrupting connection between the common node and the midpoint node when operating in the second mode of operation. Advantageously, the controller is configured to close the fourth switch when operating in the first mode of operation.

With the above electrical converter topology, it becomes possible to utilize the same converter both for conversion between three phase (multi-phase) AC and DC, and for conversion between single phase AC and DC in an easy and efficient way by exploiting the neutral terminal as return path for the single phase AC input.

Advantageously, in the second mode of operation, at least two and possibly all three of the m phase input terminals are joined to form a joined terminal, and the forward conductor of the single phase AC input is applied/connected to the joined terminal. The controller is configured to operate the first switches corresponding to the at least two of the m phase input terminals in parallel (synchronously or interleaved) through PWM. By so doing, the above topology allows for effectively utilizing the current paths of all phase inputs of the power stage, both in three phase and single phase operation, so that a same electrical power can be converted in three phase and in single phase operation without almost no additional hardware (only the fourth switch in configuration (a) needs to be added). As a result, for single phase operation there is no need for using components with higher power rating than the ones that would be needed for three phase operation for transferring a same power. Therefore, the above topology allows for efficiently utilizing the three phase topology also for single phase operation.

Advantageously, the converter comprises voltage measurement means or sensors for sensing a voltage (or other suitable signal) at each of the m phase input terminals, coupled to the controller. In the second mode of operation, the controller is configured to determine at which of the m phase input terminals the single phase AC input is applied and to operate the first switches accordingly. This allows a fully automatic configuration of the converter in the second mode of operation, without error.

Advantageously, the input filter comprises one or more input filter stages. The input filter advantageously comprises a differential mode filter and advantageously a common mode filter. The differential mode filter and the common mode filter can be distributed among the different input filter stages, which can individually comprise a differential mode filter stage and/or a common mode filter stage. Advantageously, a first differential mode filter stage comprises m+1 first inductors, m+1 first filter input nodes and m+1 first filter output nodes. m of the m+1 first filter input nodes are connected to the m phase input terminals. m of the m+1 first inductors are connected between m of the m+1 first filter input nodes and m of the m+1 first filter output nodes. The last one of the m+1 first filter input nodes is connected to the neutral terminal and the last one of the m+1 first inductors is connected between the last one of the m+1 first filter input nodes and the last one of the m+1 first filter output nodes. Advantageously, a second differential mode filter stage comprises m second inductors, m+1 second filter input nodes and m+1 second filter output nodes. m of the m+1 second filter input nodes are connected to the m phase input terminals. The m second inductors are connected between m of the m+1 second filter input nodes and m of the m+1 second filter output nodes. A last one of the m+1 second filter input nodes is connected to the neutral terminal and is connected to a last one of the m+1 second filter output nodes with no inductor being connected between the last ones of the second filter input and output nodes. The input filter can comprise either one, or both the first and the second differential mode filter stages. The input filter can comprise a series arrangement of common mode and/or differential mode filter stages. The second differential mode filter stage is advantageously arranged as last one in the series.

According to a second aspect of the disclosure, there is provided a battery charging system for charging an electric battery, or a magnetic resonance imaging apparatus comprising the electrical converter of the first aspect. Advantageously, the magnetic resonance imaging apparatus comprises a gradient amplifier, the gradient amplifier comprising a power supply unit, the power supply unit comprising the electrical converter of the first aspect.

According to a third aspect, there is provided a method of converting between single phase AC electrical power and DC electrical power as set out in the appended claims. The method advantageously makes use of the converter topology according to the first aspect.

### BRIEF DESCRIPTION OF THE DRAWINGS

Aspects of the present disclosure will now be described in more detail with reference to the appended drawings, wherein same reference numerals illustrate same features and wherein:

FIG. 1 shows a three phase electrical converter topology according to the prior art that includes a neutral connection terminal and that is bidirectional.

FIG. 2 shows a diagram with voltages over a 360° period of a balanced AC three phase mains voltage.

FIG. 3 shows a topology of an electrical converter according to a first embodiment of the present disclosure.

FIGS. 4-6 represent embodiments of input filter stages for use in electrical converters according to the present disclosure.

FIG. 7 represents the electrical converter of FIG. 3 connected to a single phase AC input.

FIG. 8A represents in the upper graph the switch voltage between one of the input terminals of the rectifier stage and the neutral input terminal of the electrical converter and in the lower graph the AC inductor currents in single-phase mode of operation.

FIG. 8B represents an enlarged portion of the upper and lower graphs of FIG. 8A, in which parallel interleaved operation of the rectifier bridge legs is clearly shown in single-phase mode of operation.

FIG. 9 represents an electrical converter that is bidirectional according to an embodiment of the present disclosure.

FIG. 10 represents an electrical converter according to another embodiment of the present disclosure, wherein the common node between the upper and lower boost bridge circuits is not connected to the midpoint of the output filter.

FIG. 11A and FIG. 11B show different variants of the rectifier power stage of the electrical converter, comprising bridge legs that are three-level half-bridges according to an embodiment of the present disclosure.

FIG. 12 represents an electrical converter with an exemplary arrangement of input filter stages.

FIG. 13 represents a diagram of a battery charging apparatus comprising an electrical converter according to the present disclosure.

### DETAILED DESCRIPTION

The terms first, second, third and the like in the description and in the claims, are used for distinguishing between similar elements and not necessarily for describing a sequential or chronological order. The terms are interchangeable under appropriate circumstances and the embodiments of the present disclosure can operate in other sequences than described or illustrated herein.

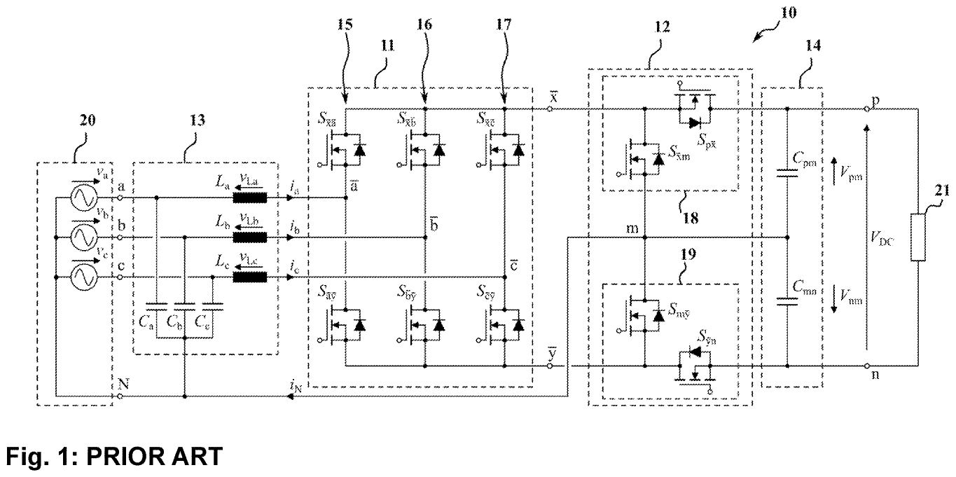

FIG. 1 shows a known electrical converter 10, referred to as the BELGIAN RECTIFIER, and further described in WO 2020/035527. Electrical converter 10 comprises two power stages 11, 12 in the form of a first three-phase active rectifier stage 11 and a second power stage 12. Electrical converter 10 further comprises an input filter 13, and an output filter 14.

The electrical converter 10 is an AC-to-DC converter that has three phase inputs a, b, c which are connected to a three-phase voltage of a three-phase AC grid 20, two DC outputs p, n which for example may be connected to a DC load 21 such as, for example, a high voltage (e.g. 800 V) battery of an electric car, and a terminal N for connecting the neutral conductor of the AC grid 20.

The two power stages 11, 12 may be seen as one ‘Integrated’ conversion stage since no high-frequency filter capacitors are present between the two power stages and since both stages use common energy storage inductors (boost inductors). In particular, the phase inductors Lₐ, L_{b}, L_{c} of the input filter 13 are used as boost inductors and are shared between both power stages 11, 12.

The rectifier stage 11 has three phase inputs ā, b̅, c̅ that are connected to the three phase inputs a, b, c via the phase inductors Lₐ, L_{b}, L_{c} of the input filter 13, and two outputs x̅, y̅. These outputs may be seen as an upper intermediate voltage node x̅, and a lower intermediate voltage node y̅, which show a ‘switched’ voltage potential caused by the switching of the second power stage 12.

The rectifier stage 11 comprises three bridge legs 15, 16, 17 which each comprise two actively switchable semiconductor devices (S_{x̅ā} and S_{āy̅} for leg 15, S_{x̅b̅} and S_{b̅y̅} for leg 16, S_{x̅c̅} and S_{c̅y̅} for leg 17) connected in the form of a half bridge configuration. Each switchable semiconductor device has an anti-parallel diode. In this example, Metal Oxide Field Effect Transistors (MOSFETs) are used for the actively switchable semiconductor devices, which each contain an internal anti-parallel body diode that may replace an external anti-parallel diode.

The second power stage 12 comprises two stacked (series connected) boost bridges 18, 19. Each boost bridge comprises boost switches (S_{x̅m}, S_{px̅} for the upper boost bridge 18 and S_{my̅}, S_{y̅n} for the lower boost bridge 19) connected in a half-bridge configuration. The middle node of the upper boost bridge 18 is connected to intermediate voltage node x̅ and the middle node of the lower boost bridge 19 is connected to intermediate voltage node y̅. The common node m of both boost stages 18, 19 is connected to the midpoint of the output filter 14 which comprises two output filter capacitors Cₚₘ, Cₘₙ that are connected in series between the upper output node p and the lower output node n.

The upper boost bridge 18 is connected between the upper output node p and the middle output node m (i.e. in parallel with the upper output filter capacitor Cₚₘ), and is arranged in a way that the intermediate voltage node x̅ can be alternately connected to the middle output node m and the upper output node p by controlling switch S_{x̅m}, wherein current can flow from the intermediate voltage node x̅ to the upper output node p via (the diode of) switch S_{px̅} when the switch S_{x̅m} is opened (not conducting), and current can flow from the intermediate voltage node x̅ to the middle output node m (or vice versa) via the switch S_{x̅m} when the switch S_{x̅m} is closed (conducting).

The lower boost bridge 19 is connected between the middle output node m and the lower output node n (i.e. in parallel with the lower output filter capacitor Cₘₙ), and is arranged in a way that the intermediate voltage node y̅ can be alternately connected to the middle output node m and the lower output node n by controlling switch S_{my̅}, wherein current can flow from the lower output node n to the intermediate voltage node y̅ via the (diode of) switch S_{y̅n} when the switch S_{my̅} is opened (not conducting), and current can flow from the middle output node m to the intermediate voltage node y̅ (or vice versa) via the switch S_{my̅} when the switch S_{my̅} is closed (conducting). It will be convenient to note that electrical converter 10 is bidirectional due to the presence of the active switches S_{px̅} and S_{y̅n} connected between a respective upper or lower intermediate node x̅, y̅ and a respective output terminal p, n.

The boost switches (S_{x̅m}, S_{my̅}) of the boost bridges 18, 19 are actively switchable semiconductor devices, such as MOSFETs.

Three AC capacitors Cₐ, C_{b}, C_{c}, which are part of the input filter 13, are interconnecting the phase inputs a, b, c in the form of a star-connection. Generally, it is advantageous that the three capacitors Cₐ, C_{b}, C_{c} have substantially equal value in order to symmetrically load the AC grid.

The neutral conductor of the three-phase AC grid is connected to the neutral connection terminal N of the converter 10. This neutral connection terminal N is further connected to the star-point of the AC capacitors Cₐ, C_{b}, C_{c} and to the common node m of the stacked boost bridges 18, 19 (and thus also to the midpoint of the output filter 14). This results in a fully symmetrical converter structure.

The bridge leg of the rectifier stage 11 receiving the phase input a, b, or c that has the highest voltage of the three-phase AC input voltage connects the corresponding phase input a, b, or c to the upper intermediate voltage node x̅ via the corresponding phase inductor (Lₐ, L_{b}, or L_{c}). To achieve this, the bridge leg connects the corresponding phase input ā, b̅, or c̅ with the node x̅. As a result, a conventional DC/DC boost converter (upper boost converter) is formed by the AC capacitor (Cₐ, C_{b}, or C_{c}) of the phase that has the highest voltage, the phase inductor (Lₐ, L_{b}, or L_{c}) of the phase that has the highest voltage, the upper boost bridge 18, and the upper output capacitor Cₚₘ. The input voltage of this upper boost converter is the voltage vₐ, v_{b}, or v_{c} of the phase input a, b, or c that has the highest voltage level, and the output voltage of this upper boost converter is the voltage Vₚₘ across the upper output capacitor Cₚₘ, having a voltage value that is substantially equal to half the total DC bus voltage (Vₚₘ≈V_{DC}/2). The formed upper boost converter can be operated by PWM modulation of the switch S_{x̅m} at a certain, possibly variable, switching frequency fₛ in order to control the current in the phase inductor (Lₐ, L_{b}, or L_{c}) of the phase that has the highest voltage.

The bridge leg of the rectifier stage 11 receiving the phase input a, b, or c that has the lowest voltage of the three-phase AC input voltage connects the corresponding phase input a, b, or c to the lower intermediate voltage node y via the corresponding phase inductor (Lₐ, L_{b}, or L_{c}). To achieve this, the bridge leg connects the corresponding phase input ā, b̅, or c̅ with the node y̅. As a result, a conventional ‘inversed’ (negative input voltage and negative output voltage) DC/DC boost converter (lower boost converter) is formed by the AC capacitor (Cₐ, C_{b}, or C_{c}) of the phase that has the lowest voltage, the phase inductor (Lₐ, L_{b}, or L_{c}) of the phase that has the lowest voltage, the lower boost bridge 19, and the lower output capacitor Cₘₙ. The input voltage of this lower boost converter is the voltage vₐ, v_{b}, or v_{c} of the phase input a, b, or c that has the lowest voltage level, and the output voltage of this lower boost converter is the voltage Vₙₘ, across the lower output capacitor Cₘₙ, having a voltage value that is substantially equal to minus half the total DC bus voltage (Vₙₘ≈−V_{DC}/2). The formed lower boost converter can be operated by PWM modulation of the switch S_{my̅} at a certain, possibly variable, switching frequency fₛ in order to control the current in the phase inductor (Lₐ, L_{b}, or L_{c}) of the phase that has the lowest voltage.

The bridge leg of the rectifier stage 11 receiving the phase input a, b, or c that has a voltage between the highest voltage and the lowest voltage of the three-phase AC input voltage is switched in a way that the corresponding phase input a, b, or c is alternately connected to the upper intermediate voltage node x̅ and the lower intermediate voltage node y̅ via the corresponding phase inductor (Lₐ, L_{b}, or L_{c}). To achieve this, the bridge leg alternately connects the corresponding phase input ā, b̅, or c̅ with the nodes x̅ and y̅. The bridge leg of the rectifier stage 11 connected with the phase input a, b, or c that has a voltage between the highest voltage and the lowest voltage of the three-phase AC input voltage may be switched in a similar fashion as a single-phase half-bridge voltage-source converter (VSC), and is operated by PWM modulation of the switches of the bridge leg at a certain, possibly variable, switching frequency fₛ in order to control the current in the phase inductor (Lₐ, L_{b}, or L_{c}) of the phase that has a voltage between the highest voltage and the lowest voltage of the three-phase AC input voltage.

In summary it can be said that two out of three bridge legs of the rectifier stage 11 are in a ‘selection state’, selecting which AC capacitor (Cₐ, C_{b}, or C_{c}) and phase inductor (Lₐ, L_{b}, or L_{c}) are part of the upper boost converter that contains upper boost bridge 18 and upper output capacitor Cₚₘ, and that is used to control the current in the phase inductor (Lₐ, L_{b}, or L_{c}) of the phase input a, b, or c that has the highest voltage of the three-phase AC input voltage, and which AC capacitor (Cₐ, C_{b}, or C_{c}) and phase inductor (Lₐ, L_{b}, or L_{c}) are part of the lower boost converter that contains lower boost bridge 19 and lower output capacitor Cₘₙ, and that is used to control the current in the phase inductor (Lₐ, L_{b}, or L_{c}) of the phase input a, b, or c that has the lowest voltage of the three-phase AC input voltage. The remaining bridge leg of the rectifier stage 11 is in an ‘active switching state’ and may be operated in a similar fashion as a single-phase half-bridge voltage-source converter (VSC). It forms a remaining switching circuit containing the remaining phase inductor (Lₐ, L_{b}, or L_{c}) and the remaining phase capacitor (Cₐ, C_{b}, or C_{c}) of the phase input a, b, or c that has a voltage between the highest voltage and the lowest voltage of the three-phase AC input voltage. The remaining switching circuit also contains the series connection of the two output capacitors Cₚₘ, Cₘₙ, and is used to control the current in the phase inductor (Lₐ, L_{b}, or L_{c}) of the phase that has a voltage between the highest voltage and the lowest voltage of the three-phase AC input voltage.

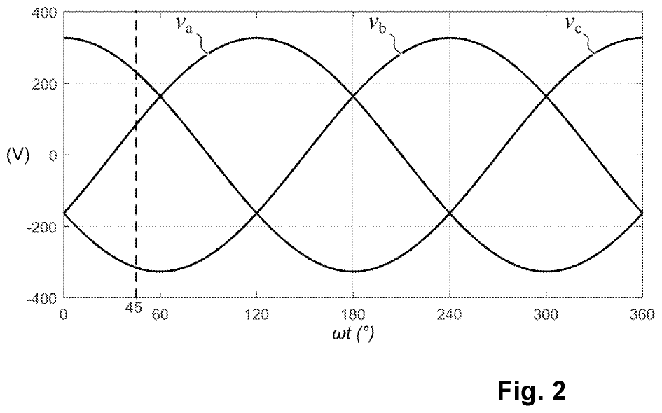

In a three-phase AC grid with substantially balanced phase voltages, for example as shown in FIG. 2, the assignment of the state of the bridge legs of the rectifier stage 11 (‘selection state’ and ‘active switching state’), as well as the assignment of the AC capacitors Cₐ, C_{b}, C_{c} and phase inductors Lₐ, L_{b}, L_{c} to the formed upper boost converter, the formed lower boost converter, and the formed remaining switching circuit changes every 60° sector of the three-phase AC input voltage depending on the voltage value of the phase inputs (a, b, c). This results in 6 unique assignments. The sequence of these assignments repeats itself every period (360°) of the AC mains voltage.

TABLE 1 summarizes the states (‘selection state’ and ‘active switching state’) of the bridge legs of the rectifier stage 11 during every 60° sector of the period (360°) of the AC mains voltage shown in FIG. 2. Note that the switches of the bridge leg that is in the ‘active switching state’ are PMW modulated, as also indicated in TABLE 1 (switch ‘PWM modulated’→S=PWM). The switches of the bridge legs that are in the ‘selection state’ are either ‘on’ or ‘off’ during the particular sector, as also indicated in TABLE 1 (switch ‘on’→S=1, switch ‘off’: →S=0). Further details of the operation of the electrical converter 1 are found in WO 2020/035527, the contents of which are incorporated herein by reference.

TABLE 1
States of the bridge legs of the rectifier stage 11 and their switches.

| Sector | Bridge leg 15 | Bridge leg 16 | Bridge leg 17 |
|---|---|---|---|
| 0°-60° | Active switching | Selection state | Selection state |
| | state | S_{x̅b̅} = 0, S_{b̅y̅} = 1 | S_{x̅c̅} = 1, S_{c̅y̅} = 0 |
| | S_{x̅ā} & S_{āy̅} = | | |
| | PWM | | |
| 60°-120° | Selection state | Selection state | Active switching |
| | S_{x̅ā} = 1, S_{āy̅} = 0 | S_{x̅b̅} = 0, S_{b̅y̅} = 1 | state (PWM) |
| | | | S_{x̅c̅} & S_{c̅y̅} = |
| | | | PWM |
| 120°-180° | Selection state | Active switching | Selection state |
| | S_{x̅ā} = 1, S_{āy̅} = 0 | state (PWM) | S_{x̅c̅} = 0, S_{c̅y̅} = 1 |
| | | S_{x̅b̅} & S_{b̅y̅} = | |
| | | PWM | |
| 180°-240° | Active switching | Selection state | Selection state |
| | state (PWM) | S_{x̅b̅} = 1, S_{b̅y̅} = 0 | S_{x̅c̅} = 0, S_{c̅y̅} = 1 |
| | S_{x̅ā} & S_{āy̅} = | | |
| | PWM | | |
| 240°-300° | Selection state | Selection state | Active switching |
| | S_{x̅ā} = 0, S_{āy̅} = 1 | S_{x̅b̅} = 1, S_{b̅y̅} = 0 | state (PWM) |
| | | | S_{x̅c̅} & S_{c̅y̅} = |
| | | | PWM |
| 300°-360° | Selection state | Active switching | Selection state |
| | S_{x̅ā} = 0, S_{āy̅} = 1 | state (PWM) | S_{x̅c̅} = 1, S_{c̅y̅} = 0 |
| | | S_{x̅b̅} & S_{b̅y̅} = | |
| | | PWM | |

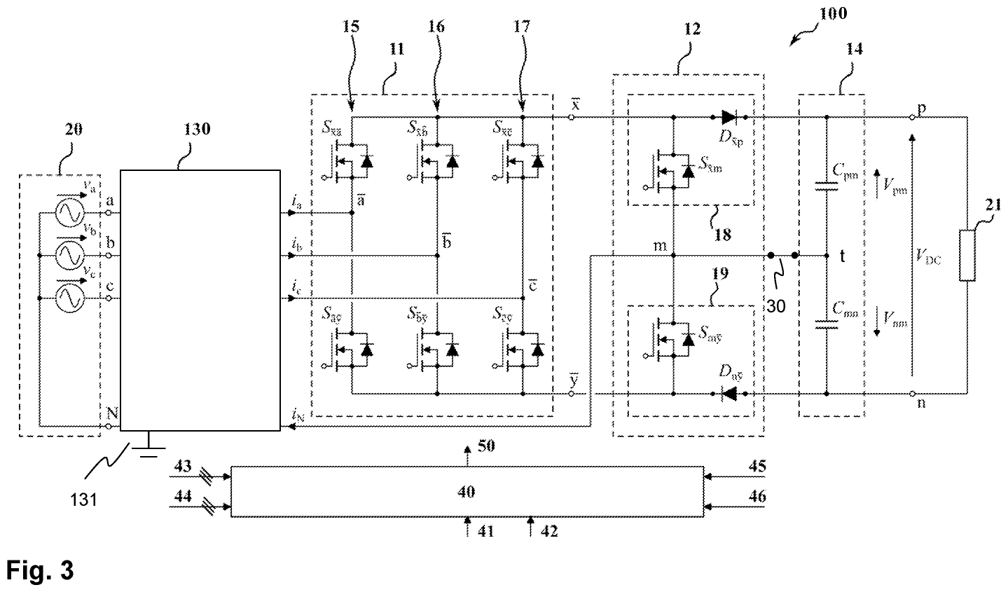

Referring now to FIG. 3, an electrical converter 100 according to a first embodiment has a topology greatly similar to the topology of the prior art converter 10 of FIG. 1. The converter 100 is shown with the phase input terminals a, b, c connected to the three phase mains supply (AC grid 20) with grid voltages vₐ, v_{b}, v_{c} and wherein the neutral conductor of the AC grid is connected to the neutral connection terminal N. The topology of the power stages 11 and 12, and of the output filter 14 can be identical between the electrical converter 10 and converter 100. In converter 100, the upper boost bridge 18 and the lower boost bridge 19 are provided with diodes D_{x̅p} for the upper boost bridge 18 and D_{ny̅} for the lower boost bridge 19 instead of the active switches S_{px̅}, S_{y̅n} with anti-parallel diodes of converter 10, making converter 100 unidirectional.

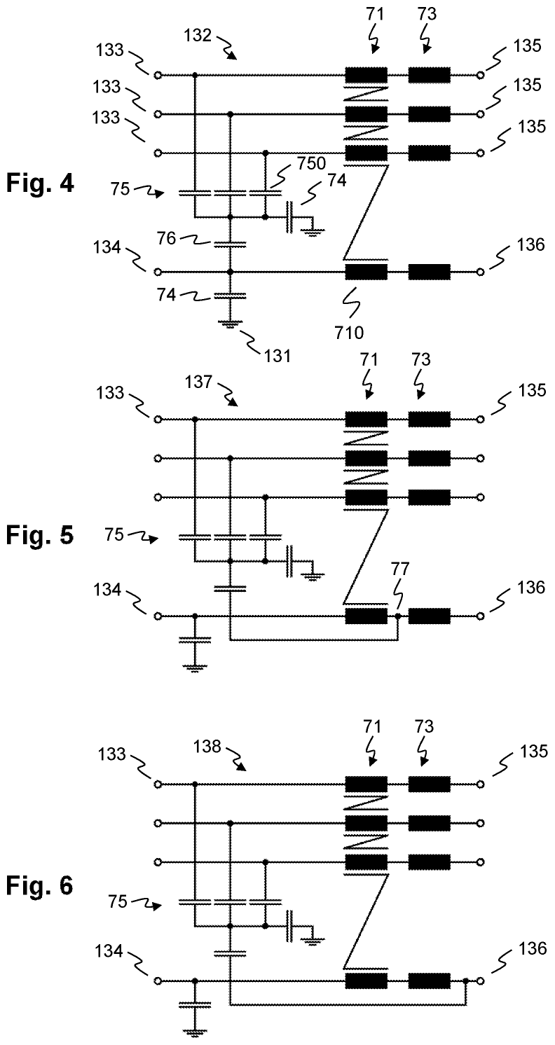

A first difference between the topology of converter 100 and converter 10 resides in the input filter 130, even though this is no requirement and converter 100 may operate according to the present disclosure with the input filter 13 of converter 10. Input filter 130 comprises m+1 input nodes with m−3 being the number of phases and m+1 output nodes. Input filter 130 advantageously comprises a ground terminal 131 for connection to protective earth. The input filter 130 comprises one or more input filter stages arranged in series between the m+1 input nodes and the m+1 output nodes. Possible input filter stages are shown in FIGS. 4, 5 and 6.

Each input filter stage 132 comprises m phase input nodes 133 and m phase output nodes 135, and a neutral input node 134 and neutral output node 136. The m phase input nodes 133 of the first input filter stage are connected to the m phase input terminals a, b, c. The m phase output nodes of the last input filter stage are connected to the input nodes a, b, and c of power stage 11. The neutral input node 134 of the first input filter stage is connected to the neutral input terminal N. The neutral output node 136 of the last input filter stage is connected to the common node m of the second power stage 12, in particular the common node between the upper and lower boost bridges 18 and 19.

Each input filter stage 132, 137, 138 advantageously comprises a common mode filter part. The common mode filter advantageously comprises a common mode filter choke 71 comprising m+1 coils 710, each coil 710 connected between a corresponding phase/neutral input node 133, 134 and a corresponding phase/neutral output node 135, 136. The common mode filter part can comprise a capacitive coupling 74 between the common mode filter choke 71 and the ground terminal 131. Capacitive coupling 74 can comprise a capacitor connected between neutral input node 134 and the ground terminal 131.

Additionally, or alternatively, each input filter stage 132, 137, 138 advantageously comprises a differential mode filter part. The differential mode filter part can comprise m or m+1 inductors 73, each connected between a corresponding phase input node 133 and a corresponding phase output node 135, and—in case of the m+1^{st} inductor—connected between the neutral input node 134 and the neutral output node 136. The coils 710 of common mode filter choke 71 and the inductors 73 can be arranged in series between their corresponding phase/neutral input node 133, 134 and their corresponding phase/neutral output node 135, 136.

Each input filter stage 132, 137, 138 advantageously comprises a capacitor network 75 forming part of the differential mode filter part. The capacitor network 75 advantageously comprises capacitors 750 connected to the m phase input nodes 133 and advantageously arranged in a star connection, even though a delta connection of the capacitors 750 between the m phase input nodes 133 is possible. The star point of the capacitor network 75 is connected to the neutral input node 134 (FIG. 4), neutral output node 136 (FIG. 6) or to a midpoint 77 between the coil 710 of the common mode filter choke 71 and the inductor 73 on the line of the neutral input node 134 (FIG. 5), possibly through an additional capacitor 76.

Referring again to FIG. 3, the input filter 13 can comprise one or a series arrangement of input filter stages 132, 137 138 as shown in FIGS. 4-6. Advantageously, the last stage in the series of input filter stages comprises a differential mode filter part with only m inductors 73. The m inductors 73 comprise input terminals connected to the m phase input nodes 133 and output terminals connected to the m phase output nodes 135. There is advantageously no inductor between the neutral input node 134 and the neutral output node 136 in this case.

A second difference of the electrical converter 100 compared to converter 10 is the presence of controllable switch 30 connecting common node m to output filter midpoint t, the operation of which will be detailed further below.

A control unit 40 is used to control all the controllable switches of the electrical converter 100, sending control signals to each switch via a communication interface 50. Furthermore, the control unit 40 comprises measurement input ports (43, 44, 45, 46), for receiving measurements of:
43: the AC-grid phase voltages vₐ, v_{b}, v_{c};
44: the AC inductor currents iₐ, i_{b}, i_{c};
45: the DC bus voltage V_{DC};
46: the DC bus mid-point voltage Vₘₙ=−Vₙₘ.

Control unit 40 is configured to receive a set-value, which may be a requested DC output voltage V_{DC}*, through input port 41 and to receive set-values for phase-imbalance current control when operating the converter in three-phase operation, through input port 42. For example, the set-values for phase-imbalance current control may be values percentages defining for each phase a requested reduction of the maximum amplitude of the phase current, in order to for example unload a particular phase when operating in three-phase operation.

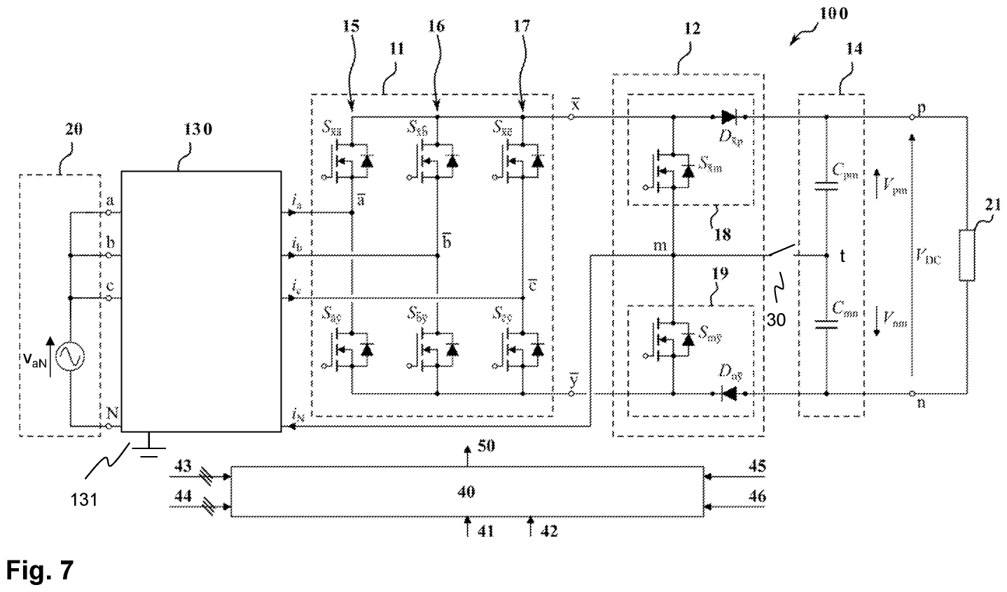

Control unit 40 is configured to operate according to two modes of operation: multi-phase AC operation and single-phase AC operation. In multi-phase AC mode of operation, a multi phase AC input, e.g. three phase input, is applied to the input terminals as shown in FIG. 3. In single-phase AC mode of operation, as shown in FIG. 7, one or a plurality of the m phase input terminals a, b, c, such as at least two or advantageously all three are shorted and the forward conductor of a single phase AC input is applied to the shorted input terminals and the return conductor to the neutral input terminal N.

The goal of the control unit 40 is to control the output voltage V_{DC} to a requested set-value V_{DC}* that is received from an external unit via input port 41.

In both multi-phase and single phase mode of operation, additionally, the current drawn from the phase inputs (a,b,c) is shaped substantially sinusoidal and controlled to be substantially in phase with the corresponding phase voltage. Note that the currents drawn from the phase inputs (a,b,c) are equal to the filtered (low-passed) currents iₐ, i_{b}, i_{c} in the inductors 73 of the (last stage of) input filter 130, since the high-frequency ripple of the inductor currents iₐ, i_{b}, i_{c} is filtered by the AC capacitors arranged in the one or more input filter stages of the input filter 130 as described above. Therefore, controlling the currents drawn from the phase inputs (a, b, c) can be done by controlling the, for example low-pass filtered, inductor currents iₐ, i_{b}, i_{c}.

The output voltage V_{DC} can be controlled by control unit 40 using a cascaded control structure, comprising an outer voltage control loop and inner current control loop as described in relation to FIG. 3 of WO 2020/035527, the contents of which are incorporated herein by reference.

In multi-phase AC mode of operation, the current controller is split into three individual current controllers, each one controlling a respective current iₐ, i_{b}, i_{c} in a respective phase input line as follows:
a first individual current controller is used for controlling the current in the phase input a,b,c, that has the highest voltage of the three-phase AC voltage. This control is done by PWM modulation of the switch S_{x̅m} of the upper boost converter containing upper boost bridge 18;
a second individual current controller is used for controlling the current in the phase input a,b,c, that has the lowest voltage of the three-phase AC voltage. This control is done by PWM modulation of the switch S_{my̅} of the lower boost converter containing lower boost bridge 19;
a third individual current controller is used for controlling the current in the phase input a,b,c, that has a voltage between the highest voltage and the lowest voltage of the three-phase AC voltage. This control is done by the PWM modulation of the switches of the bridge leg of the remaining switching circuit containing the bridge leg of the rectifier that is in the ‘active switching state’.

In multi-phase AC mode of operation, the controller 40 controls switch 30 to be closed (conductive state between nodes m and t). This allows to operate the converter 100 in the same way as for converter 10 as described in WO 2020/035527. Particularly, closing switch 30 allows to actively balance the voltage across the two output capacitors Cₚₘ and Cₘₙ, for example by controlling the voltage Vₙₘ across the lower output capacitor Cₘₙ to be substantially equal to half the DC bus voltage V_{DC}.

In single-phase AC mode of operation, the controller 40 controls switch 30 to be open (non-conductive state between nodes m and t). Referring to FIG. 7, the operation of electrical converter 100 is as follows.

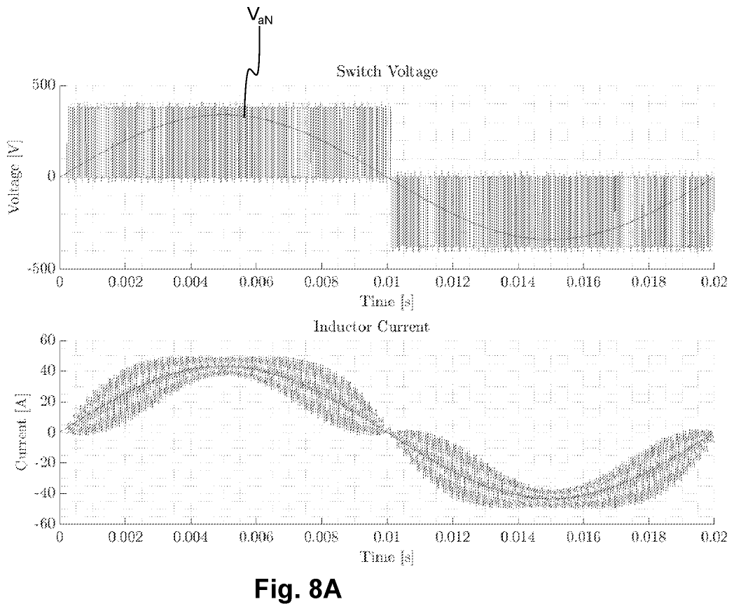

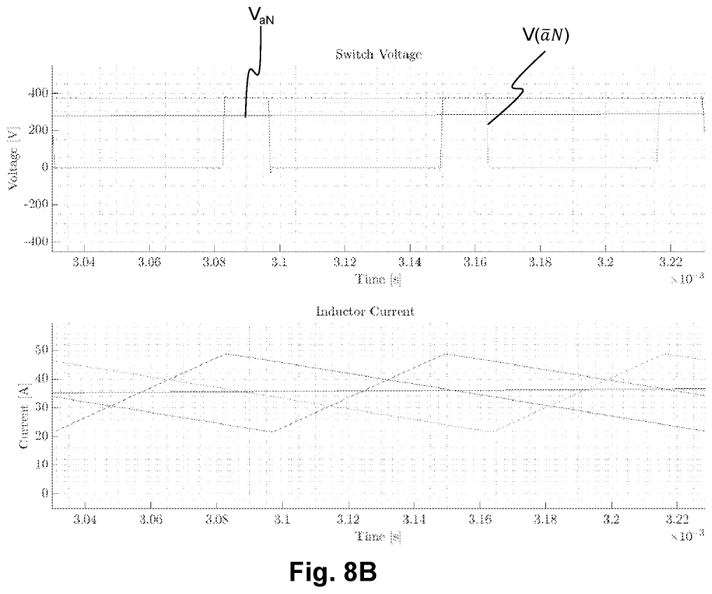

Referring to FIGS. 7 and 8A-B, during the positive portion of the AC input voltage V_{aN}, switch S_{x̅m} of the upper boost bridge 18 is opened (non-conducting), while switch S_{my̅} of the lower boost converter bridge 19 is closed (conducting). As a result, intermediate voltage node x̅ is continuously connected to output node p and intermediate voltage node y̅ is continuously connected to common node m and to output node n, assuming that diodes D_{x̅p} and D_{ny̅} are conducting due to the current flowing from x̅ to p and from n to y̅ when the power flow of the converter is from AC input to DC output. Since switch S_{my̅} is closed, nodes n and y̅ are continuously connected to the neutral input terminal N and hence to the bottom of the AC input voltage.

The switches of the rectifier bridge legs 15-17 (S_{x̅ā} and S_{āy̅} for leg 15, S_{x̅b̅} and S_{b̅y̅} for leg 16, S_{x̅c̅} and S_{c̅y̅} for leg 17) are PWM controlled by controller 40, such that nodes ā, b̅, c̅ are connected to nodes x̅ and y̅ alternatingly. During the positive portion of the AC input voltage V_{aN}, PWM is advantageously performed such that the average voltage of the nodes ā, b̅, c̅ with respect to the bottom of the AC input (line) voltage (at nodes N, y̅, n) is equal to the AC input voltage. In other words, the inductors of the input filter 130 whose terminals are connected to the nodes ā, b̅, c̅ should be in steady state condition, i.e. the volt-seconds of these inductors should be 0 in one period of the input voltage.

During the negative portion of the of the AC input voltage V_{aN}, switch S_{x̅m} of the upper boost bridge 18 is closed (conducting), while switch S_{my̅} of the lower boost converter bridge 19 is opened (non-conducting). As a result, common node m is continuously connected to intermediate voltage node x̅ and to output node p, and intermediate voltage node y̅ is continuously connected to output node n, assuming that diodes D_{x̅p}, and D_{ny̅} are conducting due to the current flowing from x̅ to p and from n to y̅ when the power flow of the converter is from AC input to DC output. Since switch S_{x̅m} is closed, nodes p and x̅ are continuously connected to the neutral input terminal N.

The switches of the rectifier bridge legs 15-17 (S_{x̅ā} and S_{āy̅} for leg 15, S_{x̅b̅} and S_{b̅y̅} for leg 16, S_{x̅c̅} and S_{c̅y̅} for leg 17) are PWM controlled by controller 40, such that nodes ā, b̅, c̅ are connected to nodes z and y alternatingly. During the negative portion of the of the AC input voltage V_{aN}, PWM is advantageously performed such that the average voltage of the nodes ā, b̅, c̅ with respect to the bottom of the AC input (line) voltage (at nodes N, x̅, p) is equal to the AC input voltage. In other words, the inductors of the input filter 130 whose terminals are connected to the nodes ā, b̅, c̅ should be in steady state condition, i.e. the volt-seconds of these inductors should be 0 in one period of the input voltage. Since the input voltage at nodes a, b, c is negative with respect to N, the average voltage at nodes ā, b̅, c̅ with respect to N will also be negative. This is possible due to the fact the switch S_{x̅m} connects N to x̅ during the negative portion of V_{aN}.

It is alternatively possible to not operate any of the switches S_{x̅m} and S_{my̅} in the second mode of operation. These switches will hence remain open (non-conducting), and the operation as described above for the second mode of operation is effected through the diodes arranged in anti-parallel with the switches S_{x̅m} and S_{my̅}. However, by operating the switches S_{x̅m} and S_{my̅} in the second mode of operation, losses are reduced compared to the case of operating exclusively through the anti-parallel diodes.

Controller 40 can be configured to PWM control the switches of the rectifier bridge legs 15-17 (S_{x̅ā} and S_{āy̅} for leg 15, S_{x̅b̅} and S_{b̅y̅} for leg 16, S_{x̅c̅} and S_{c̅y̅} for leg 17) so as to deviate slightly from the steady state condition indicated above in order to be able to dynamically control the (sum of the) inductor currents iₐ, i_{b}, i_{c} to adjust the power factor, e.g. to ensure that unity power factor is applied. Advantageously, in single phase mode of operation, controller 40 is configured to control the AC input current, which is the sum of the inductor currents iₐ, i_{b}, i_{c}, to have a sinusoidal shape which is furthermore in phase with the grid voltage. Advantageously, PWM control of the switches of the bridge legs 15-17 is effected such that the AC input current is equally distributed among the (connected) phase input terminals a, b, c, i.e. iₐ=i_{b}=i_{c}.

In single-phase AC mode of operation, the DC output voltage can be controlled through an inner current control loop allowing to control the magnitude of the inductor currents iₐ, i_{b}, i_{c}. An outer (closed) voltage control loop can determine an output DC voltage error which can be fed as input parameter to the inner control loop to adjust the AC input current (i.e. the sum of the inductor currents iₐ, i_{b}, i_{c}) in order to make the output voltage error evolve to zero.

In single-phase AC mode of operation, the controller 40 is advantageously configured to operate the switches of the different bridge legs 15, 16 and 17 (S_{x̅ā} and S_{āy̅} for leg 15, S_{x̅b̅} and S_{b̅y̅} for leg 16, S_{x̅c̅} and S_{c̅y̅} for leg 17) in parallel. This allows to spread the transmitted power across all available bridge legs of the first power stage 11. By so doing, in single phase mode of operation, a same power can be transferred as in multi-phase mode of operation, assuming that all input phase terminals a, b, c are used in single-phase operation.

Advantageously, the corresponding switches of the bridge legs 15, 16 and 17 are operated synchronously. It is alternatively possible to operate the corresponding switches of bridge legs 15, 16 and 17 in interleaved fashion during single-phase mode of operation. The inductor currents and switch voltage for this kind of operation are shown in FIG. 8A and in an enlarged view FIG. 8B. Interleaved operation reduces current ripple of the summed current in the intermediate nodes z and y and of the AC input current (i.e. the sum of the inductor currents iₐ, i_{b}, i_{c}), As a result, input filter 130 can be made smaller.

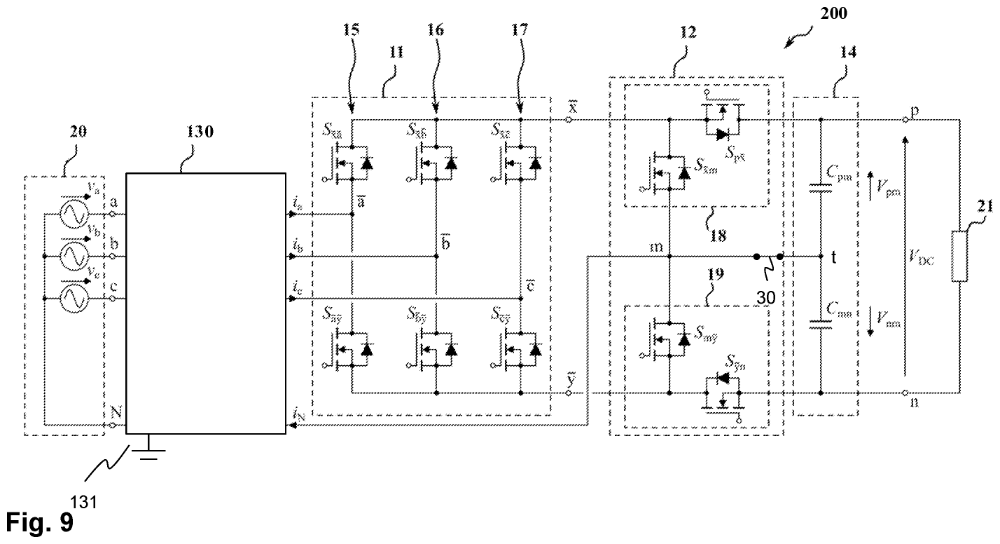

The electrical converter shown in FIGS. 3 and 7 is unidirectional since the output power stage 12 contains diodes, only allowing power to be drawn from the electrical AC grid 20 and provide this power at its output to a load 21. FIG. 9, on the other hand, shows an electrical converter 200 that is bidirectional, since the diodes D_{x̅p} and D_{ny̅} of the second (boost) power stage 12 of the converter shown in FIG. 3 have been supplemented with controllable semiconductor switches S_{px̅}, S_{y̅n} connected between a respective upper and lower intermediate node x̅, y̅ and a respective output terminal p, n. In single-phase mode of operation, the switches S_{px̅}, S_{y̅n} are advantageously operated by controller 40 to remain closed. The AC single phase input phase voltage is connected similarly as in FIG. 7.

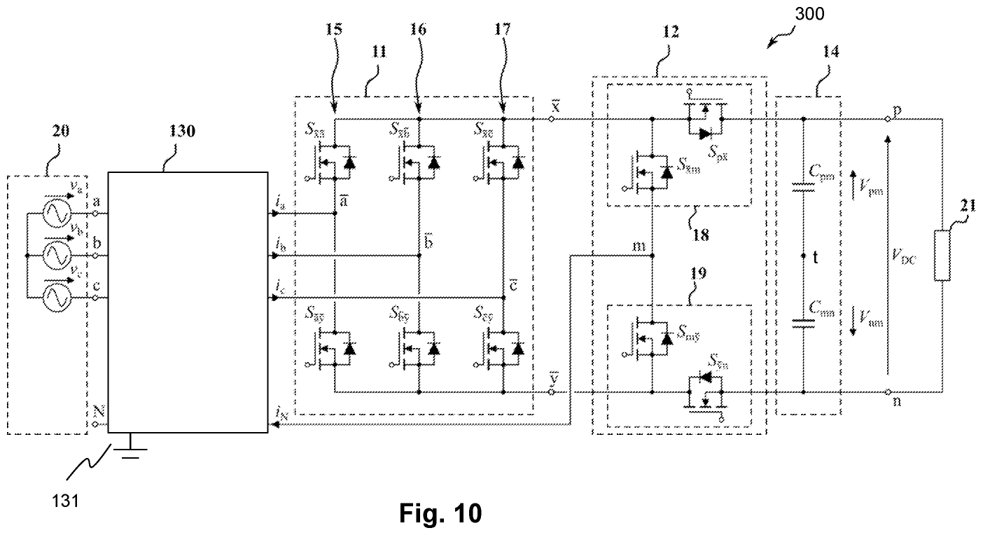

In FIG. 10, an electrical converter 300 is shown, where the connection between boost bridge midpoint node m and output filter midpoint node t is absent. As a result, switch 30 of FIGS. 7 and 9 can be dispensed with. In multi-phase mode of operation, the neutral connection terminal N is not used and switches S_{x̅m} and S_{my̅} can be operated with a same PWM signal to operate synchronously, mimicking a single switch. This converter does not provide a path for a return current equal to the sum of the three phase currents to flow back to the neutral conductor of the grid during multi-phase operation, and might be advantageous in case no neutral conductor of the electrical grid is present and/or in case the amplitudes of the three phase currents drawn from the three-phase AC grid do not need to be controlled fully independently, for example when it is sufficient to draw currents with substantially equal amplitudes. The single-phase mode of operation is identical to the case of converter 200 as shown in FIG. 9.

Still referring to FIG. 10, the output filter 14 can alternatively be provided as a single capacitor filter, wherein the single capacitor is connected between output terminals p and n. In this case, midpoint node t is absent.

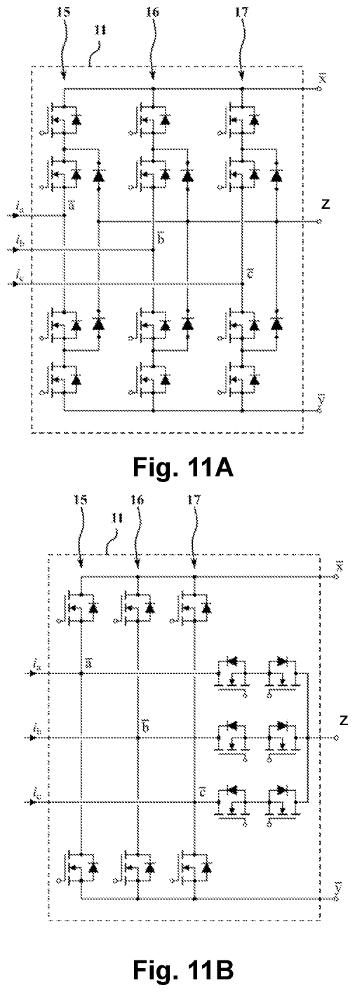

FIG. 11A, 11B show different variants of the three-phase active rectifier 11, which may be used in either converters 100, 200 and 300. In FIG. 11A and FIG. 11B the bridge legs are three-level half-bridges instead of two-level half bridges for FIG. 3 and FIG. 9. In the three-phase active rectifier 11 of FIG. 11A the half-bridges are NPC based (NPC stands for ‘Neutral Point Clamped’) while in the three-phase active rectifier 11 of FIG. 11B the half-bridges are T-type based. Note that in both FIG. 11A, 11B the three-level bridge legs comprise a middle output node z. Middle output node z can be connected to the common mode m of the boost stages, or can be connected to the midpoint node t of the output filter, i.e. middle output node z can be connected to the left side terminal or the right side terminal of switch 30.

The bridge leg of the rectifier stage in FIG. 11A, 11B that is connected with the phase input a, b, or c that has a voltage between the highest voltage and the lowest voltage of the three-phase AC input voltage may be switched in a way that the corresponding phase input a, b, or c is alternately connected to the upper intermediate voltage node x̅, the lower intermediate voltage node y̅, and the middle output node z via the corresponding phase inductor, wherein an additional voltage potential is applied to the phase inductor which may allow to further reduce the high-frequency ripple of the inductor current.

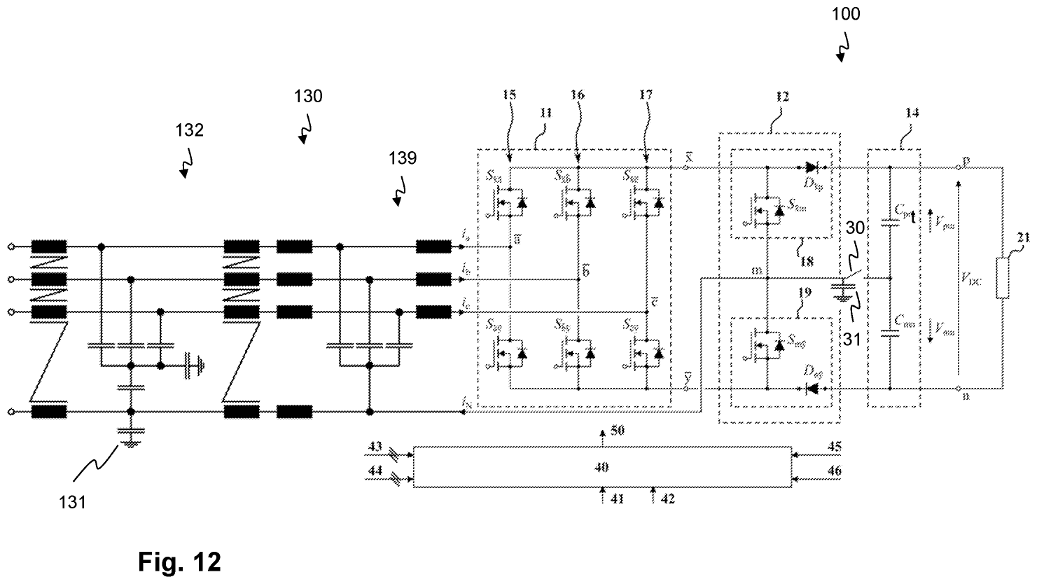

Referring to FIG. 12, electrical converter 100 is shown with a possible arrangement of the input filter 130, comprising two input filter stages 132 and 139. Input filter stage 139 is a pure differential mode filter stage and does not comprise an inductor having terminals connected between the neutral input and output nodes of the filter stage. Switch 30 further comprises a capacitor 31 connected between a switch terminal and protective earth.

In single phase AC mode of operation, controller 40 can read the AC-grid voltage signals of the input terminals a, b, c at port 43 so as to determine which ones (all three or less) of the input terminals are connected to the single phase AC grid. This allows controller 40 to determine which of the bridge legs 15, 16, 17 to control.

Electrical converters according to the present disclosure can, for example, be used for converting a three-phase AC voltage or a single phase AC voltage from an electrical grid, which may be a low voltage (e.g. 380-400 or 240 Vrms at 50 Hz frequency) grid, into a high DC output voltage (e.g. 700-1000 V).

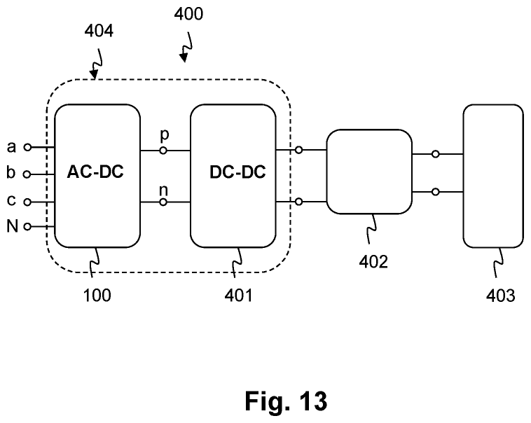

Referring to FIG. 13, a battery charging apparatus 400 comprises a power supply unit 404. The power supply unit 404 is coupled to an interface 402, e.g. comprising a switch device, which allows to connect the power supply unit 404 to a battery 403. The power supply unit 404 comprises any one of the electrical converters 100 as described hereinabove coupled to a DC-DC converter 401. The DC-DC converter 401 can be an isolated DC-DC converter. The DC-DC converter can comprise a transformer effecting galvanic isolation, particularly in case of wired power transfer between power supply unit 404 and the battery 403. The DC-DC converter can comprise a pair of coils which are inductively coupled through air, such as in case of wireless power transfer. In some cases, the interface 402 can comprise a plug and socket, e.g. in wired power transfer. Alternatively, the plug and socket can be provided at the input (e.g., at nodes a, b, c, N).

1. An electrical converter for converting electrical power between a multi-phase AC input and a DC output, the electrical converter comprising:
m=3 phase input terminals (a, b, c), a neutral terminal (N) and two output terminals (p, n),
a first power stage comprising a bridge rectifier connected to each of the m phase input terminals and an output connected to an upper intermediate node (x̅) and a lower intermediate node (y̅), wherein the bridge rectifier comprises first active switches (S_{x̅ā}, S_{x̅b̅}, S_{x̅c̅}, S_{āy̅}, S_{b̅y̅}, S_{c̅y̅}),
an input filter connected between the m phase input terminals (a, b, c), the neutral terminal (N) and the first power stage,
a second power stage comprising an upper boost stage comprising a second active switch (S_{x̅m}) connected between the upper intermediate node (x̅) and a common node (m), and a lower boost stage comprising a third active switch (S_{my̅}) connected between the common node (m) and the lower intermediate node (y̅), wherein the common node (m) is connected to the neutral terminal (N), wherein the second active switch and the third active switch each comprise an anti-parallel diode,
an output filter comprising at least one filter capacitor (Cₚₘ, Cₘₙ) connected between the second power stage and the output terminals (p, n), and
a controller operably connected to the first, second and third active switches (S_{x̅ā}, S_{x̅b̅}, S_{x̅c̅}, S_{āy̅}, S_{b̅y̅}, S_{c̅y̅}, S_{x̅m}, S_{my̅}), wherein the controller is configured to operate according to a first mode of operation for converting the multi-phase AC input applied at the m phase input terminals to the DC output or vice versa,
wherein the output filter comprises a midpoint node (t) and the common node (m) is not connected to the midpoint node (t), or the common node (m) is connected to the midpoint node through a fourth switch, or the output filter does not comprise a midpoint node (t), and
wherein the controller is configured to operate according to a second mode of operation for converting a single phase AC input applied between at least one of the m phase input terminals (a, b, c) and the neutral terminal (N) to the DC output or vice versa, wherein the second active switch (S_{x̅m}) and the third active switch (S_{my̅}) are configured to assume inverse states in the second mode of operation.

2. The electrical converter of claim 1, wherein in the second mode of operation the controller is configured to operate the first switches connected to the at least one of the m phase input terminals (a, b, c) through pulse width modulation.

3. The electrical converter of claim 1, wherein during a positive voltage half-period (V_{aN}) of the single phase AC input, the second active switch (S_{x̅m}) is configured to be in a non-conducting state, while the third active switch (S_{my̅}) is configured to be in a conducting state, and during a negative voltage half-period (V_{aN}) of the single phase AC input, the third active switch (S_{my̅}) is configured to be in a non-conducting state, while the second active switch (S_{x̅m}) is configured to be in a conducting state.

4. The electrical converter of claim 1, wherein the common node (m) is connected to the midpoint node through the fourth switch, wherein the controller is configured to open the fourth switch for interrupting connection between the common node (m) and the midpoint node (t) when operating in the second mode of operation.

5. The electrical converter of claim 4, wherein the controller is configured to close the fourth switch (30) when operating in the first mode of operation.

6. The electrical converter of claim 1, wherein the controller is configured to operate the second active switch (S_{x̅m}) and the third active switch (S_{my̅}) to assume the inverse states in the second mode of operation.

7. The electrical converter of claim 1, wherein the output filter comprises an upper filter capacitor (Cₚₘ) connected between an upper output terminal (p) of the output terminals and the midpoint node (t), and a lower filter capacitor (Cₚₘ) connected between the midpoint node (t) and a lower output terminal (n) of the output terminals.

8. The electrical converter of claim 1, wherein the input filter comprises a first input filter stage comprising first inductors and m+1 first filter input nodes, wherein the m+1 first filter input nodes are respectively connected to the m phase input terminals (a, b, c) and the neutral terminal (N).

9. The electrical converter of claim 8, wherein the first input filter stage comprises m+1 first inductors, each first inductor coupled to a corresponding one of the m phase input terminals and the neutral terminal (N).

10. The electrical converter of claim 1, wherein the first input filter stage comprises a capacitor network connecting each of the m phase input terminals (a, b, c) to the neutral terminal (N) through a capacitor.

11. The electrical converter of claim 1, wherein the input filter (130) comprises a common mode filter.

12. The electrical converter of claim 1, wherein the bridge rectifier comprises m bridge legs, wherein the controller is configured to operate the first switches (S_{x̅ā}, S_{x̅b̅}, S_{x̅c̅}, S_{āy̅}, S_{b̅y̅}, S_{c̅y̅}) at corresponding positions in the bridge legs in an interleaved manner in the second mode of operation.

13. The electrical converter of claim 1, wherein the controller comprises a measurement input port configured to receive a measurement of phase currents (iₐ, i_{b}, i_{c}) through the first inductors, wherein the controller comprises a current control loop coupled to the second and third active switches (S_{x̅m}, S_{my̅}), wherein the current control loop is configured to generate a pulse width modulation control signal fed to the second and third active switches based on the phase currents measured (iₐ, i_{b}, i_{c}) in the first mode of operation.

14. The electrical converter of claim 1, wherein the controller comprises a measurement input port configured to receive a measurement of phase currents (iₐ, i_{b}, i_{c}) through the first inductors, wherein the controller is configured to control the first switches with a pulse width modulation control signal to obtain a substantially equal phase current (iₐ, i_{b}, i_{c}) through the at least two of the m phase input terminals in the second mode of operation.

15. The electrical converter of claim 1, wherein in the first mode of operation, the controller is configured to operate the first switches of a bridge leg of the bridge rectifier connected to the phase input terminal having an intermediate voltage between a highest voltage and a lowest voltage so as to alternatingly connect the phase input terminal having the intermediate voltage to the upper intermediate node and the lower intermediate node.

16. The electrical converter of claim 1, wherein in the second mode of operation, the m phase input terminals (a, b, c) are shorted to provide a common input terminal for connecting a forward conductor of the single phase AC input.

17. The electrical converter of claim 1, wherein the controller comprises a measurement input port configured to receive a signal representative of a voltage input at each of the m phase input terminals (a, b, c), wherein the controller is configured to automatically determine which of the first switches to operate based on the signal (43).

18. A battery charging system, comprising a power supply unit, the power supply unit comprising the electrical converter of claim 1.

19. A method of converting between single phase AC electrical power and DC electrical power, the method comprising:
providing the electrical converter of claim 1,
connecting a forward conductor of a single phase AC input to at least one of the m phase input terminals (a, b, c),
connecting a return conductor of the single phase AC input to the neutral terminal (N), and
operating the controller in the second mode of operation.

20. The method of claim 19, wherein the forward conductor is connected to at least two of the m phase input terminals (a, b, c).
